(19) United States
(12) Patent Application Publication
(10) Pub. No.: US 2003/0134664 A1
(43) Pub. Date: Jul. 17, 2003

(54) System, Method, and apparatus for improving the performance of space division multiple access and other systems that shape antenna beams by employing postdetection polarimetric beamsteering and utilizing genetic algorithms to synthesize beams

(76) Inventor: Gregory Zancewicz, Melissa, TX (US)

Correspondence Address: SOFER & HAROUN, L.L.P., Suite 910, 317 Madison Avenue, New York, NY, 10017, US

(21) Appl. No.: 10/284,426

(22) Filed: Oct. 30, 2002

Related U.S. Application Data
(60) Provisional application No. 60/336,420, filed on Oct. 30, 2001.

(51) Int. Cl. H04Q 7/20

(52) U.S. Cl. 455/562; 455/450

(57) ABSTRACT

The present invention relates to a system for increasing the capacity of SDMA and other systems that shape antenna beams by employing post-detection polarimetric beamsteering to synthesize not only an antenna pattern dedicated to a particular source, but also a polarization that more closely matches that of the source than under current systems. A first set of an antenna array are used having a plurality of antenna elements that receive electromagnetic signals from one or more sources. A second set of an antenna array, located with the first set, is polarized in an orthogonal arrangement to each element of the first set of antenna arrays. At least one receiver is configured to convert an RF input either directly to a baseband signal or indirectly through a first digital IF output and then to a baseband signal. At least one baseband signal processor, for processing baseband signals is provided.

### RELATED APPLICATIONS

The present application relates back to a provisional applications, Ser. NO. 60/336,420, filed Oct. 30, 2001, entitled “Space Division Multiple Access Method and Apparatus Employing Postdetection Polarimetric Beamsteering,” and incorporated herein by reference.

In addition, the present application relates back to a utility application, filed August 2000, entitled “Application for United States Letters Patent for Genetic Adaptive Antenna Array Processor,” which in turn relates back to a provisional application, Serial No. 60/147,098, filed Aug. 4, 1999, entitled “Genetic Adaptive Antenna Array Processor,” and incorporated herein by reference.

### FIELD OF THE INVENTION

The present invention relates to wireless communications systems. More particularly, the present invention relates to novel and improved methods and apparatus to increase the capacity of existing SDMA systems and other systems that shape antenna beams by employing polarimetry along with adaptive antenna arrays, sparse antenna arrays, and genetic algorithms.

### BACKGROUND

Current antenna systems synthesize a receiver system's polarization by adjusting the amplitude and phase of each of two orthogonally polarized antenna system's outputs and combining the resulting signals. If, for example, separate but co-located horizontally (H) and vertically (V) polarized antenna systems are available, current systems can synthesize slant linear polarization by combining the two systems' outputs in phase and in equal proportion. Also, current systems can synthesize circular polarization by combining H and V in equal proportion, but by shifting one of the two components in phase by 90°. Finally, current systems can synthesize arbitrary elliptical polarizations by combining H and V in unlike proportions with an arbitrary phase shift.

Synthetic Aperture Radar (SAR) have deployed polarimetric antenna systems extensively and have yielded promising results in enhancing the contrast of desired radar returns in the presence of other reflecting objects producing undesired returns. For example, a landmark study by Swartz of Jet Propulsion Laboratory SAR images of the San Francisco Bay area achieved contrast improvement on the order of 9 dB (see A. A. Swartz et al., “Optimal polarizations for achieving maximum contrast in radar images,” Journal of Geophysical Research, Vol. 93, pp. 15252-15260, 1987). Subsequent studies have yielded similar results (J. G. Teti et al., “Application of the Polarimetric Matched Image Filter to the Assessment of SAR Data from the Mississippi Flood Region,” Geoscience and Remote Sensing Symposium, Vol. 3, pp. 1368-1370, 1994; L. M. Novak et al., “Optimal Polarimetric Processing for Enhanced Target Detection,” IEEE Transactions on Aerospace and Electronic Systems, Vol. 29, No. 1, pp. 234-244, 1993; and F. T. Ulaby and C. Elachi, Radar Polarimetry for Geoscience Applications, Artech House, 1990).

SDMA systems are communications systems which employ antenna arrays with adaptive beamsteering control to narrow the array's coverage area to a small sector encompassing one or more stations. Confining antenna beam coverage to a small area reduces interference from stations outside the coverage area and generally increases the capacity of the overall communications system. In the case of multiaccess interference (MAI) tolerant protocols such as code division multiple access (CDMA) or spread spectrum multiple access (SSMA), the number of users supported is directly proportional to the carrier-to-interference-and-noise (CINR) ratio supported within the channel. Thus, if an operator subdivides a homogeneous 60° coverage sector into multiple 6° coverage sectors—also assumed to be homogeneous—it could decrease the number of users by a factor of 10 and increase capacity approximately ten-fold.

Conventional SDMA systems employ single polarization antenna arrays and steer such arrays either: (a) electronically through the use of radio frequency (RF) phase shifters and attenuators applied to the RF or some intermediate (IF) signal; or (b) digitally through the use of digital weighting factors applied directly to the baseband signal. Digital adaptive beamforming has the advantage that it can synthesize independent antenna patterns for each received signal.

When a wireless operator employs a second co-located orthogonally polarized antenna array at the same location as the first array, the use of independent digital beamformers for each array permits the receiver to synthesize not only an antenna pattern that favors some particular source, but also a polarization that closely matches that of the source. If a number of sources are within the coverage area of the SDMA beam and each source is assumed to be randomly polarized with respect to any other source, then the system could theoretically reduce interference by a factor of two. As discussed above, this should create a two-fold increase in capacity in a MAI-tolerant link. In the example above cited from radar literature, contrast is analogous to carrier-to-interference (CIR) ratio. The 9 dB contrast improvement obtained in the Swartz study, if applied to a communications system context, would amount to almost a 10-fold improvement in capacity.

### OBJECTS OF THE INVENTION

The present invention includes the following objectives:

1. Expand capacity of wireless networks. The present invention aims to increase capacity in wireless networks by exploiting the polarization of individual stations within the networks.

2. Increase the speed of transmission. The present invention aims to enable wireless to transmit traffic faster than they would in the absence of the invention.

3. Minimize interference between stations. The present invention aims to minimize interference between stations within wireless networks lying within the same coverage area.

4. Decrease the incremental cost of wireless networks. The present invention aims to reduce the incremental cost of deploying and operating wireless networks by utilizing sparse antenna arrays.

### SUMMARY OF THE INVENTION

The present invention provides a system, method, and apparatus for exploiting the polarization of individual stations within a wireless network. Synthesizing not only the antenna pattern but also the polarization of the individual pattern can decrease mutual interference and therefore increase overall network capacity.

The present invention implements two independent and orthogonally polarized antenna arrays, each of which may be adaptively controlled at baseband in both phase and amplitude. The present invention combines the outputs of each antenna array coherently in a way that maximizes the measured and/or estimated CINR at the output of the receiver which terminates the two antenna arrays.

In addition, the present invention provides methods for utilizing sparse antenna arrays to reduce the cost of implementing SDMA and other systems that shape antenna beams.

Finally, the present invention provides a system, method, and apparatus for utilizing genetic algorithms to solve optimization problems in SDMA systems and other systems that shape antenna beams.

The present invention can apply to any type of wireless network, regardless of the modulation technique utilized, and apply to both the uplink and downlink channels. Thus, the present invention can apply to wireless local area networks (WLAN) or wireless wide area networks (WWAN).

### BRIEF DESCRIPTION OF THE DRAWINGS

FIG. 1 is a diagram of the overall Apparatus defined by this invention.

FIG. 2 is a detailed diagram of the Baseband Processor, a component of the Apparatus.

FIG. 3 is a detailed diagram of the Digital Signal Processor, a component of the Baseband Processor.

FIG. 4 is a flow chart of the overall method disclosed in this invention.

### DETAILED DESCRIPTION OF THE PREFERRED EMBODIMENTS

In general, the present invention has the following overall structure:

At least two antenna arrays comprising a plurality of antenna elements that can receive electromagnetic signals from one or more sources.

Such antenna arrays are co-located, but orthogonally polarized to each other. Parallel receivers and baseband signal processors.

Components that can synthesize digital weights for antenna elements. Beamsteering Processor that can employ search algorithms capable of exploiting signal properties of any modulation technique utilized by a wireless operator, including without limitation such techniques utilized by WLAN operators and WWAN operators.

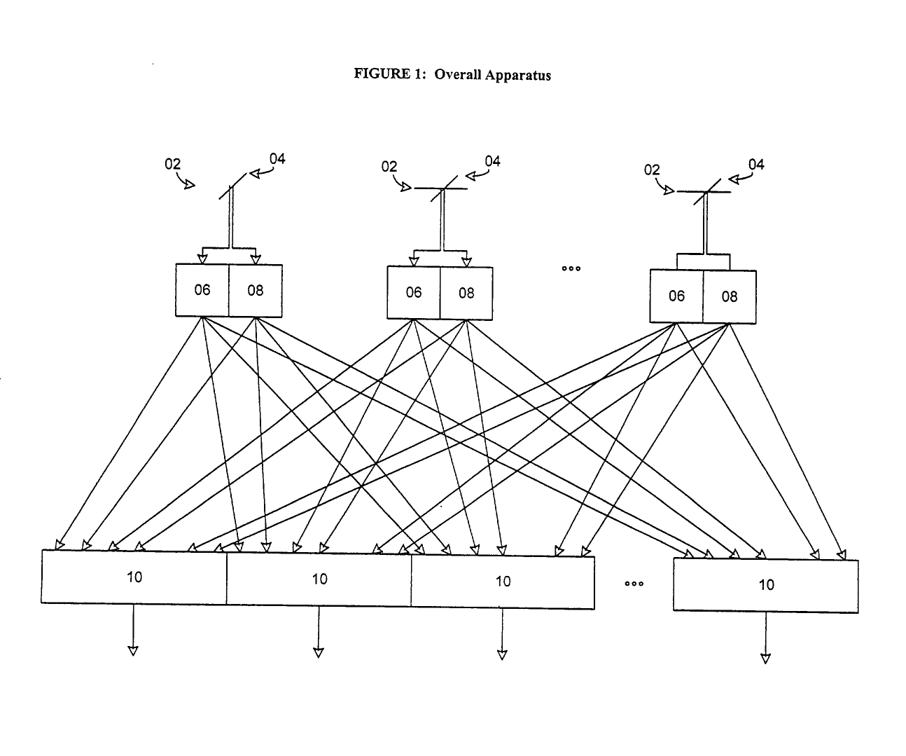

FIG. 1 shows an Antenna Array 02 comprising a plurality of antenna elements that can receive electromagnetic signals from one or more remote sources. All of the elements of Array 02 are similarly polarized. A second Antenna Array 04 is co-located with Array 02, but polarized in a sense orthogonal to that of Array 02. That is, polarization involves more than the physical orientation of an antenna element. It also involves the relative phase of each orthogonal element's output. Each Receiver 06 and 08 converts a RF input to a digital IF output. There is one Receiver 06 for each antenna element in polarization A (02 in the figure) and one Receiver 08 for each antenna element in polarization B (04 in the figure). The functions of Receivers 06 and 08 are identical, but the present invention ascribes different numbers to the A-pol and B-pol Receivers in order to track the connections later in the signal processing chain) Each Baseband Signal Processor 10 accepts multiple digital IF inputs and produces a single demodulated baseband signal that corresponds to a single user.

In an alternative embodiment, the present invention can convert a RF input directly to a baseband signal, rather than first to a digital IF output and then to a baseband signal.

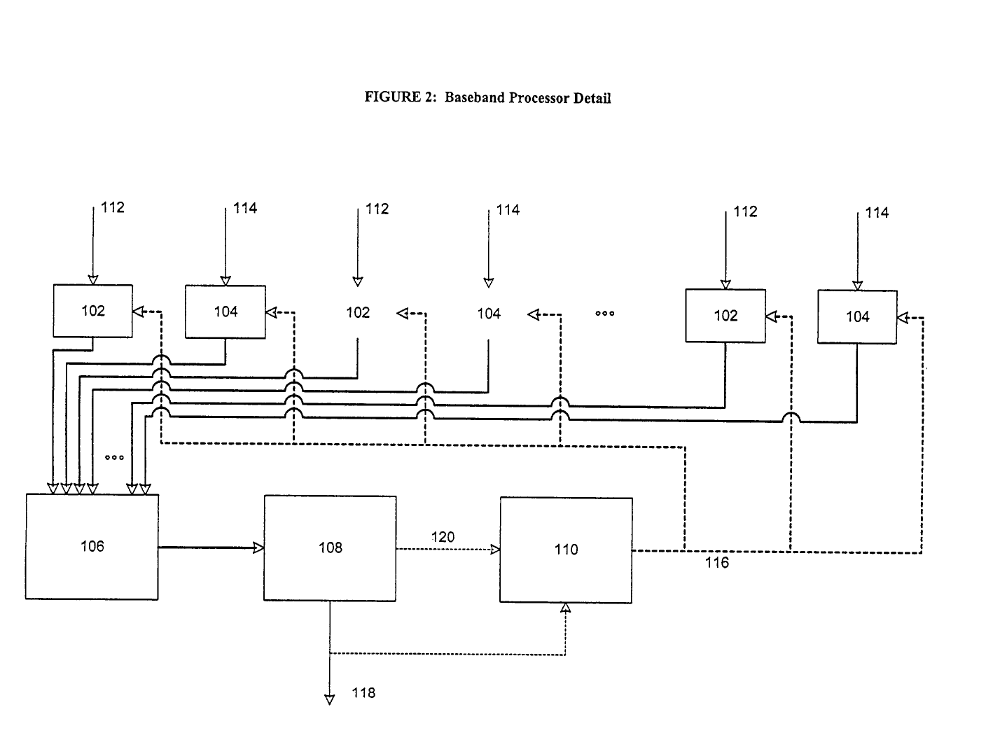

FIG. 2 shows the detailed structure of each Baseband Signal Processor 10. Each Baseband Signal Processor 10 comprises Digital Signal Processors 102 and 104; Array Output Combiner 106; Demodulator 108; and Beamsteering Processor 110.

Each Digital Signal Processor 102 and 104 accepts a digital IF input as well as a complex-valued weighting factor. The complex weighting factor is equivalent to a pair of real-value factors, with one factor corresponding to the in-phase (“I”) component of the complex factor and the second factor corresponding to the quadrature (“Q”) component of the complex factor.

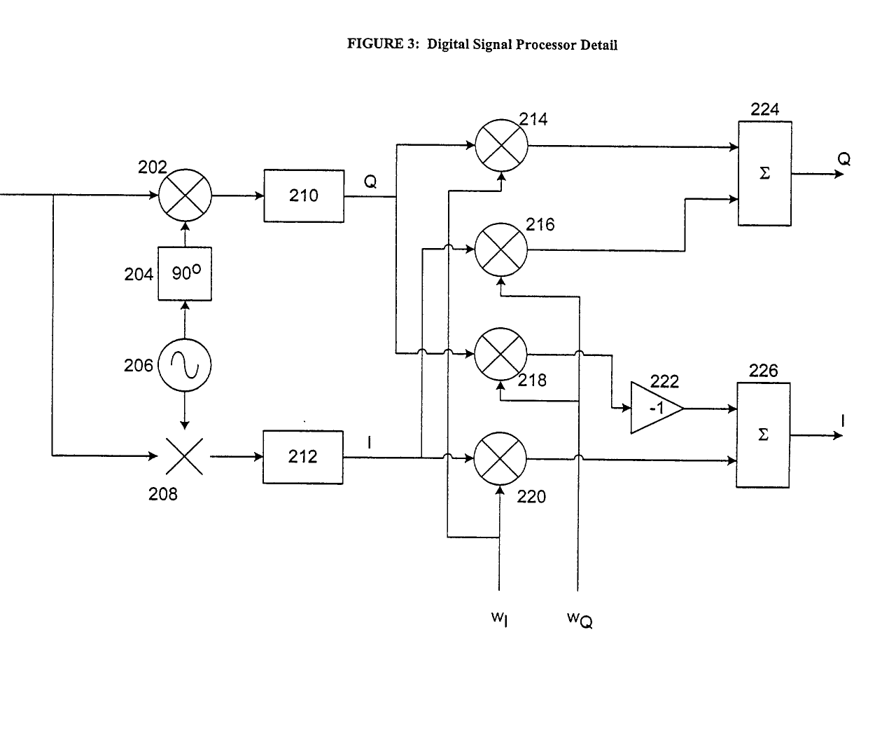

FIG. 3 shows the preferred embodiment of each Digital Signal Processor (102 or 104). Each Digital Signal Processor comprises two Digital Multipliers 202, 208, and 214-220; a Digital Local Oscillator 206; a Phase Shifter 204; Filters 210 and 212; an Inverter 222; and Combiners 224 and 226. The preferred embodiment of the Digital Signal Processor is equivalent to other embodiments with two input signal branches in which the input signal in one branch is multiplied by the cosine of the product of time and the input signal radian frequency while the input signal in the second branch is multiplied by the sine of the same product.

All embodiments of each Digital Signal Processor share the same approach of providing unique receivers for each element of two orthogonally polarized antenna arrays, providing a unique digital signal processor for each user, and applying optimal amplitude and phases to each signal for each user. Such an approach synthesizes a unique antenna pattern and polarization for each user.

Each Digital Signal Processor 102 and 104 performs a coherent digital demodulation of the digital IF input signal by producing digital sequences corresponding to the I and Q components of the original signal. The Digital Signal Processor (102 or 104) then multiplies the resulting complex digital sequence by the complex weighting factor in accordance with the method illustrated in FIG. 3.

Array Output Combiner 106 sums a number of complex-valued digital input sequences to produce a single complex-valued digital output sequence.

Demodulator 108 accepts a single complex-valued digital input sequence and demodulates the digital input sequence to produce a real-valued digital output sequence. The functions implemented within Demodulator 108 depend on the specific modulation waveforms and protocols employed, but could include without limitation: amplitude modulation (AM), frequency modulation (FM), minimum shift keying (MSK), phase shift keying (PSK), quadrature amplitude modulation (QAM), as well as more complex composite modulations such as CDMA or orthogonal frequency division multiplexing (OFDM).

Demodulator 108 also produces a real-valued digital output which corresponds to an estimate of some figure of merit of the digital input sequence, including without limitation carrier-to-noise ratio (CNR), carrier-to-interference ratio (CIR), carrier-to-interference-and-noise ratio (CINR), bit error rate (BER), frame error rate (FER), packet error rate (PER), or energy-per-bit-to-noise (Eb/No) ratio.

Beamsteering Processor 110 accepts an input corresponding to some figure of merit of array performance, including without limitation the examples cited above, and/or an output demodulated sequence. The Beamsteering Processor produces an array of complex beamsteering weighting factors. The Beamsteering Processor 110 may implement any arbitrary beamsteering technique, including without limitation minimum mean square error (MMSE) techniques which seek to match the array output to some desired response; techniques which attempt to maximize the received signal-to-noise ratio (SNR); and Linearly constrained minimum variance (LCMV) techniques which seek to minimize the variance at the output of array subject to linear constraints. The present invention can employ specific methods to calculate the array weights adaptively from the Beamsteering Processor 110 objective function. These methods include without limitation genetic algorithms, least mean squares (LMS) algorithms, and recursive least squares (RLS) algorithms.

Antenna Arrays 02 and 04 receive electromagnetic RF signals at each of two orthogonal polarizations, as discussed above. For simplicity, the present invention refers to the polarization of Antenna Array 02 as Polarization A and the polarization of Antenna Array 04 as Polarization B. The elements of Array 02 feed the RF signals in Polarization A to Receivers 06. The elements of Array 04 feed the RF signals in Polarization B to Receivers 08.

Within Receivers 06, the Polarization A RF signals are converted to some IF and are in turn converted to digital sequences. Within Receivers 08, the Polarization B RF signals are converted to some IF and are in turn converted to digital sequences. Receivers 06 and 08 feed polarization A and B digital IF sequences, respectively, to Baseband Signal Processors 10.

Within each Baseband Signal Processor 10, Polarization A digital IF sequences are directed to Polarization A Digital Signal Processors 102 and Polarization B digital IF sequences are directed to Polarization B Digital Signal Processors 104. Within Digital Signal Processors A and B, digital IF sequences are converted digitally to coherent in-phase (I) and quadrature (Q) components, as discussed above. Each Digital Signal Processor 102 and 104 multiplies the resulting digital I and Q signals by the I and Q weighting factors provided by Beamsteering Processor 110.

The Array Output Combiner 106 within each Baseband Signal Processor accepts the outputs of all Digital Signal Processors and outputs the sum of all inputs to Demodulator 108. Demodulator 108 produces a Demodulated Signal Output 118. In an alternative embodiment, Demodulator 108 may provide an additional sequence which provides some measure of a figure of merit to the Beamsteering Processor 110, as discussed above.

Demodulator 108 transmits to Beamsteering Processor 110 a figure of merit sequence 120 and/or a demodulated output sequence 118. Beamsteering Processor 110 then adjusts the antenna element weights supplied to Digital Signal Processors 102 and 104 in accordance with the beamsteering algorithm implemented.

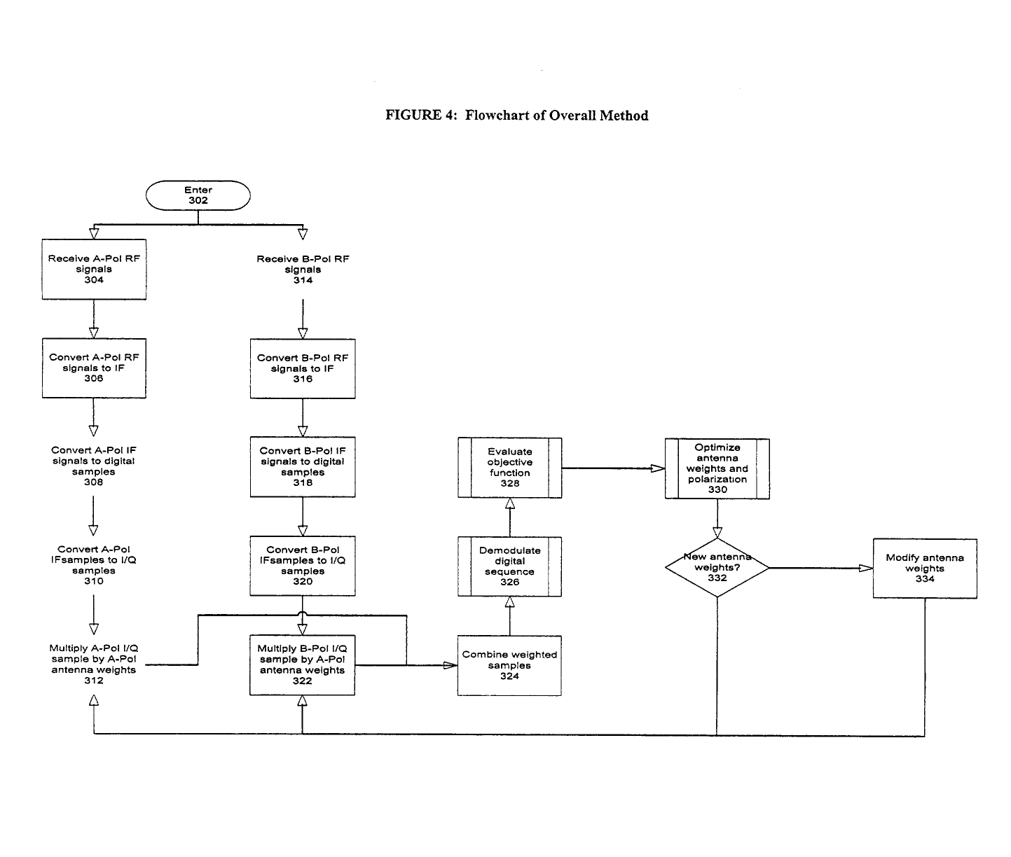

FIG. 4 contains a flow chart illustrating the overall method.

Preceding Step 302, one or more users that are either fixed or mobile generate one or more RF signals, each of which are in one distinct polarization. (The method applies to both the uplink and downlink channels.)

The process begins at Step 302. At Step 304, the Polarization A (“A-Pol”) Array 02 receives RF signals. At Step 306, Receivers 06 converts A-Pol RF signals to IF signals. At Step 308, Receivers 06 converts A-Pol IF signals to a sequence of digital IF samples.

At Step 310, each Digital Signal Processor 102 within each user's Baseband Signal Processor 10 converts the A-Pol digital IF samples 112 to I and Q components as discussed above.

As discussed above, in an alternative embodiment, the present invention can include Receivers 06 that convert RF signals directly to baseband signals.

At Step 312, Digital Signal Processor 102 multiplies the A-Pol I and Q samples by the last updated weight corresponding to the Digital Signal Processor's particular antenna element and user.

Steps 314 though 322 are analogous operations for the B-Pol signals and samples.

At Step 324, Array Output Combiner 106 within each Baseband Signal Processor 10 adds all weighted I and Q samples.

At Step 326, Demodulator 108 demodulates the resulting I and Q sequence in accordance with the protocol being employed within the overall communications system. Demodulator 108 may also calculate one or more figures of merit to be used in the overall weight optimization process, as described above.

At Step 328, Beamsteering Processor 110 evaluates some optimization function based on the output of Demodulator 108.

At Step 330, Beamsteering Processor 110 optimizes the antenna weighting factors in accordance to the optimization algorithm implemented.

If the Beamsteering Processor 110 has produced a new set of antenna weights, then a decision is made in Step 332 to execute Step 334 and update the antenna weights in Step 334. Otherwise, the process continuously executes the loop from Steps 312 and 322 through Step 334 while simultaneously executing Steps 304-310 and Steps 314-320.

The Beamsteering Processor 110 described in the present invention simultaneously and independently adjusts weighting factors controlling both the Polarization A Array 02 and the Polarization B Array 04. Since the present invention assigns each user an independent Baseband Processor 10, of which the Beamsteering Processor 110 is a part, the invention effectively synthesizes for each user not only a dedicated antenna pattern, but also a dedicated polarization of the antenna pattern. The present inventor believes that this technique is novel, unique, and non-obvious. Although some existing antenna systems employ dual-polarized antennas, the polarization of individual users is exploited only through non-coherent diversity combining schemes such as switched diversity, maximal-ratio combining, or equal gain combining.

Because the polarization of signals is determined by multipath scattering and not by the type of modulation technique utilized by wireless operators, the present invention applies to any type of wireless service. In particular, the genetic algorithm covered by the present invention can exploit signal properties of any modulation technique utilized by a wireless operator, including without limitation such techniques utilized by: (a) WLAN operators, e.g., direct sequence spread spectrum (DSSS) in 802.11b, OFDM in 802.11a, and OFDM in 802.11g; and (b) WWAN operators, e.g., DSSS or frequency hopping spread spectrum (FHSS) in CDMA and non-orthogonal basic modulation techniques in other types of networks like AM, FM, phase modulation (PM), amplitude shift keying (ASK), frequency shift keying (FSK), PSK, and QAM. Because the present invention implements the algorithm at the link adaptation level for the 802.11a standard, for example, a wireless operator needs no modification of network adaptors.

Because most WLAN networks are deployed in indoor environments, the polarization of signals is particularly affected by the larger number of reflecting surfaces in such environments. The gain the present invention can generate will depend on the number and relative strength of the multipath components.

In the preferred embodiment of the invention, Arrays 02 and 04 are implemented as sparse antenna arrays. Antenna arrays are considered sparse when the spacing between antenna elements exceeds approximately one wavelength in free space for the electromagnetic signal of interest. While sparse arrays can be cost-effective, they do not generally perform well in mitigating interference due to the presence of numerous sidelobes and grating lobes which are sensitive to signals in undesired directions. The use of polarimetry provides additional interference suppression, however, which can compensate for sidelobe and grating lobe interference.

Conventional antenna arrays achieve increased angular resolution by distributing antenna elements over a longer baseline or aperture. Generally, antenna arrays employed with mobile wireless base transceiver stations (BTS) employ arrays with densely and uniformly spaced antenna elements. Since the BTS complexity and cost increase with the number of active antenna elements supported, the costs associated with increasing antenna beam resolution beyond a certain point can become prohibitive.

By contrast, decreasing the number of active antenna elements while maintaining a longer baseline has the undesired effect of creating large amplitude sidelobes or, in the case of very sparse arrays, grating lobes with roughly the same amplitude as the desired (main) antenna lobe. The consequence of operating an antenna array with large sidelobes is to degrade overall CINR, since energy is entering the receiver from unintended directions.

The present invention proposes two preferred embodiments of a wide aperture sparse antenna array which have shown promising results in the uplink and/or downlink. First, one preferred embodiment of the array takes the form of a sparse antenna array spaced along tick marks of a Golomb ruler. A Golomb ruler minimizes the number of marks needed to generate any given set of measurements. For example, a ruler with marks at 0, 1, 3 can measure 1, 2, 3, or 4 units, but has only 3 tick marks. Optimal Golomb Rulers have been found with up to 24 marks.

The present invention includes a sparse uplink array at the BTS spaced along tick marks of a Golomb ruler, where one tick mark represents one-half wavelength at the RF frequency. When the output signals at each antenna element are weighted with uniform amplitude, this array will produce a single main lobe with sidelobe levels on the order of −6 dB. The present invention permits adjustment of both phase and amplitude in the uplink array by means of a genetic algorithm which optimizes CINR for each user in the uplink channel.

A second embodiment of the present invention calls for antenna elements spaced uniformly with a density of 0.3 to 0.4, where a density of one represents the density of a dense uniformly spaced array over the same baseline (i.e. one antenna element every one-half wavelength). The present invention calls for this array to be used in the downlink with uniform amplitude weighting but distinct phases assigned to each downlink channel.

The preferred embodiment of the invention also employs one or more genetic algorithms within Beamsteering Processor 110 in order to calculate the weights applied within Digital Signal Processors 102 and 104, as described in prior art (G. Zancewicz, “Application for United States Letters Patent for Genetic Adaptive Antenna Array Processor,” Attorney Docket 01049.0020U1, August 2000; and G. Zancewicz, “Genetic Adaptive Antenna Array Processor,” U.S. Provisional Patent Application, Serial No. 60/147,098, filed Aug. 4, 1999). Genetic algorithms have been shown to be robust in solving optimization problems which are non-linear, discontinuous, and/or rich in local extrema (D. E. Goldberg, Genetic Algorithms in Search, Optimization, and Machine Learning, Addison-Wesley, 1989). Genetic algorithms have also been applied successfully in related antenna array and/or polarimetry problems (K. Sarabandi and E. S. Li, “Characterization of Optimum Polarization for Multiple Target Discrimination Using Genetic Algorithms,” IEEE Transactions on Antennas and Propagation, Vol. 45, No. 12, pp. 1810-1817, 1997; and R. Haupt, “An Introduction to Genetic Algorithms for Electromagnetics,” IEEE Transactions on Antennas and Propagation, Vol. 42, No. 7, pp.993-999, 1994).

Classical adaptive array systems utilize optimal techniques to maximize S/I or S/N ratios. Such techniques are designed to resolve crisply N sources with N+1 antenna elements. However, most mobile operators face traffic conditions where the number of sources significantly exceed the number of antenna elements, the arrivals of signals or multipath at receivers are correlated, and the noise is colored rather than white. For example, WLAN operators typically operate in indoor environments, in which there exist many reflecting surfaces that can cause significant multipath interference. CDMA operators typically have 15 or more co-channel users. These conditions make it difficult for optimal techniques to maximize S/I or S/N ratios.

The present invention utilizes genetic algorithms to optimize the synthesizing of beams and assignment of sub-beams to an individual MS. People are starting to utilize genetic algorithms in a wide variety of optimization problems, including problems related to fixed antenna arrays and radar polarimetry. They appear to be well-suited to problems with discontinuities, constraints, and/or large numbers of local minima. Genetic algorithms mimic cellular evolution in the following ways:

The method represents trial solutions as chromosomes.

The method equates trials results to the fitness of individuals.

The method utilizes reproduction, crossover, and mutation mechanisms to ensure evolution of strong solutions with a random component.

In the case of antenna arrays, a genetic algorithm would have the following features:

Code antenna element weights as 16-bit binary numbers.

Equate the CINR to fitness.

Represent n number of trial solutions as chromosomes.

Assume a c probability of crossover.

Assume a m probability of mutation.

Given such features, a genetic algorithm could produce and the present invention would store a set of solutions that maximized the CINR. The algorithm would compare each new solution with the best solution previously generated. After a certain number of trials, the algorithm should generate a solution that met the minimum CINR needed to synthesize a beam.

While the utility application describes the present invention in detail with particular reference to preferred embodiments, sequence of steps, and number of steps, other embodiments, step sequences, and a larger or smaller number of steps can achieve the same results. Variations and modifications of the present invention will be obvious to those skilled in the art. The inventor intends to cover in the claims of the patent application all such variations, modifications, and equivalents.

What is claimed is:

1. A system for increasing capacity of SDMA and other systems that shape antenna beams by employing post-detection polarimetric beamsteering to synthesize not only an antenna pattern dedicated to a particular source, but also a polarization that more closely matches that of the source than under current systems, comprising:
a. A first set of at least one antenna array, which in turn comprises a plurality of antenna elements that receive electromagnetic signals from one or more sources;
b. A second set of at least one antenna array co-located with said first set of antenna arrays, wherein each of the antenna elements in said second set is polarized in an orthogonal arrangement to each antenna element of said first set of antenna arrays;
c. One or more receivers configured to convert a RF input either directly to a baseband signal, and indirectly through first to a digital IF output and then to a baseband signal; and
d. One or more baseband signal processors, which in turn comprise digital signal processors, array output combiners, demodulators, and beamsteering processors, for processing baseband signals.
